(19) United States
(12) Patent Application Publication
(10) Pub. No.: US 2025/0375886 A1
(43) Pub. Date: Dec. 11, 2025

(54) VISION SYSTEM FOR AN ENERGY TRANSFER SYSTEM

(71) Applicant: Caterpillar Inc., Peoria, IL (US)

(72) Inventors: Mathew FLEMMER, Christchurch (NZ); Vaughan WEATHERALL, Dunedin (NZ)

(73) Assignee: Caterpillar Inc., Peoria, IL (US)

(21) Appl. No.: 18/736,056

(22) Filed: Jun. 6, 2024

(51) Int. Cl. B25J 9/16; B25J 5/02; B25J 11/00; B60S 5/02; G05D 1/661; G06T 7/70; G06V 20/50

(52) U.S. Cl. CPC B25J 9/1697; B25J 5/02; B25J 11/008; G05D 1/661; G06T 7/70; G06V 20/50; B60S 5/02; G06T 2207/10012; G06T 2207/10028

(57) ABSTRACT

In some implementations, a system may detect that an energy transfer operation for a work machine is to be initiated. The system may obtain, via a camera system, image data depicting an external environment based on detecting that the energy transfer operation is to be initiated, wherein the external environment is external to a housing of a robotic system that is associated with the system. The system may perform, based on the image data, one or more actions via the robotic system to initiate the energy transfer operation.

### TECHNICAL FIELD

The present disclosure relates generally to an energy transfer system and, for example, to a vision system for an energy transfer system.

### BACKGROUND

Machines (e.g., that utilize a type of energy source other than fossil fuel, such as electricity, hydrogen, methanol, ammonia, or other sources of energy other than a fossil fuel), such as vehicles or other mobile machines, that are at least partially powered by on-board energy storage systems (e.g., batteries, hydrogen fuel cells, chemical storage components, among other examples) can be environmentally-friendly alternatives to machines powered by fossil fuels. However, in many cases, when a machine operates throughout the day, the on-board energy storage system needs to be replenished several times over the course of the day (e.g., at least five (5) times per day) to ensure that the machine has enough power to continuously operate. In some cases, a technician can connect one or more energy replenishing connectors to one or more receptacles of the machine (e.g., that are associated with an on-board energy storage system of the machine) to allow for the on-board energy storage system of the machine to be replenished. However, this manual process is subject to error (e.g., where a connector is not accurately inserted into a receptacle). This can result in a sub-optimal replenishment of the on-board energy storage system for the machine, such as in terms of an increased amount of time needed to replenish the energy for the machine and a decreased available energy level on-board the machine. Sub-optimal replenishment can impact operations of a machine, such as by reducing an amount of time that the machine is available to perform powered operations (e.g., as compared to an amount of time that the machine needs to be replenished with energy) and by reducing an amount of power that is available to perform the powered operations. Sub-optimal replenishment of the on-board energy storage system for the machine can, in some cases, also degrade the on-board energy storage system of the machine, which impacts a performance and/or an operable life of the on-board energy storage system, and of the machine.

Typically, automated and/or autonomous processes utilize image data to ensure precise functionality. Image data can be provided to a system as an input for one or more tasks, such as object detection, object recognition, and/or segmentation, among other examples, which may enable the system to perform automated and/or autonomous operations. The image data may be captured via a camera system. The system may obtain camera data at various points throughout the automated and/or autonomous operations (e.g., as components and/or objects in an environment move). This may decrease the efficiency of the automated and/or autonomous operations because there may be a delay associated with capturing, obtaining, and/or analyzing the image data at the various points. Additionally, a machine may operate in environments associated with harsh conditions (e.g., extreme temperatures, high wind speeds, a large amount of debris, and/or other harsh conditions), such as a mine site and/or other work sites. As a result, an automated and/or autonomous process for energy transfer to the machine in the manner described above may increase the risk of damage to components of the system due to the components operating in and/or being exposed to the harsh environment for an increased amount of time.

U.S. Pat. No. 11,065,768 (“the '768 patent”) discloses a method for automatically calibrating a camera-robot system having tool offsets. The '768 patent discloses a process for automatically calibrating camera-robot systems with end of arm tool or tool offsets. While the '768 patent discloses a process for automatically calibrating camera-robot systems with end of arm tool or tool offsets, the '768 patent does not disclose providing any means to protect the robot and/or components of the robot (e.g., from environmental conditions) during the calibration and/or during an energy transfer operation. Additionally, the '768 patent does not disclose a process for calibrating operations of the robot for an energy transfer operation.

The energy transfer system and/or the vision system of the present disclosure solves one or more of the problems set forth above and/or other problems in the art.

### SUMMARY

An energy transfer system may include a housing; a robotic system movable between an interior of the housing and an external environment, wherein the robotic system includes an end effector for coupling with receptacles for energy transfer; a camera system configured on an exterior of the housing; and one or more controllers configured to: detect that an energy transfer operation for a work machine is to be initiated; obtain, via the camera system and based on detecting that the energy transfer operation is to be initiated, first image data depicting the external environment; and selectively cause, based on the first image data, the robotic system to move from the interior of the housing to the external environment to initiate the energy transfer operation.

A method may include detecting, by a system, that an energy transfer operation for a work machine is to be initiated; obtaining, by the system and via a camera system, first image data depicting an external environment based on detecting that the energy transfer operation is to be initiated, wherein the external environment is external to a housing of a robotic system that is associated with the system; and performing, by the system and based on the first image data, one or more actions via the robotic system to initiate the energy transfer operation.

A camera system may include one or more cameras; one or more memories; and one or more processors, communicatively coupled to the one or more memories, configured to: obtain an indication that an energy transfer operation for a work machine is to be initiated; obtain, via the one or more cameras and based on detecting that the energy transfer operation is to be initiated, image data depicting an external environment, wherein the external environment is external to a housing of an energy transfer system; and provide, to one or more components of the energy transfer system, the image data to initiate the energy transfer operation.

### BRIEF DESCRIPTION OF THE DRAWINGS

FIG. 1 is a diagram of an example work machine described herein.

FIGS. 2A-2B are diagrams of examples of the receptacle access point described herein.

FIGS. 3A-3B are diagrams of an example energy transfer system.

FIG. 4 is a diagram of an example of a vision system for the energy transfer system described herein.

FIG. 5 is a diagram of an example of an external environment of the energy transfer system described herein.

FIG. 6 is a diagram of the energy transfer system described herein.

FIG. 7 is a flowchart of an example process associated with the vision system for the energy transfer system described herein.

### DETAILED DESCRIPTION

This disclosure relates to an energy transfer system that is configured to enable an energy transfer to a work machine, which is applicable to any work machine that is at least partially powered by a non-fossil-fuel-based energy storage system (e.g., energy other than fossil-fuel-based energy), such as a battery system. The work machine may be any type of machine configured to perform operations associated with an industry such as mining, construction, farming, transportation, or any other industry. Although some examples are described herein in associated with electrical energy transfer, the techniques, implementations, systems, devices, and/or components described herein may be similarly applicable for other types of energy transfer, such as hydrogen transfer, biofuel transfer, and/or gas transfer (e.g., propane, liquefied petroleum gas, compressed natural gas, liquefied natural gas, or other types of gas), among other examples.

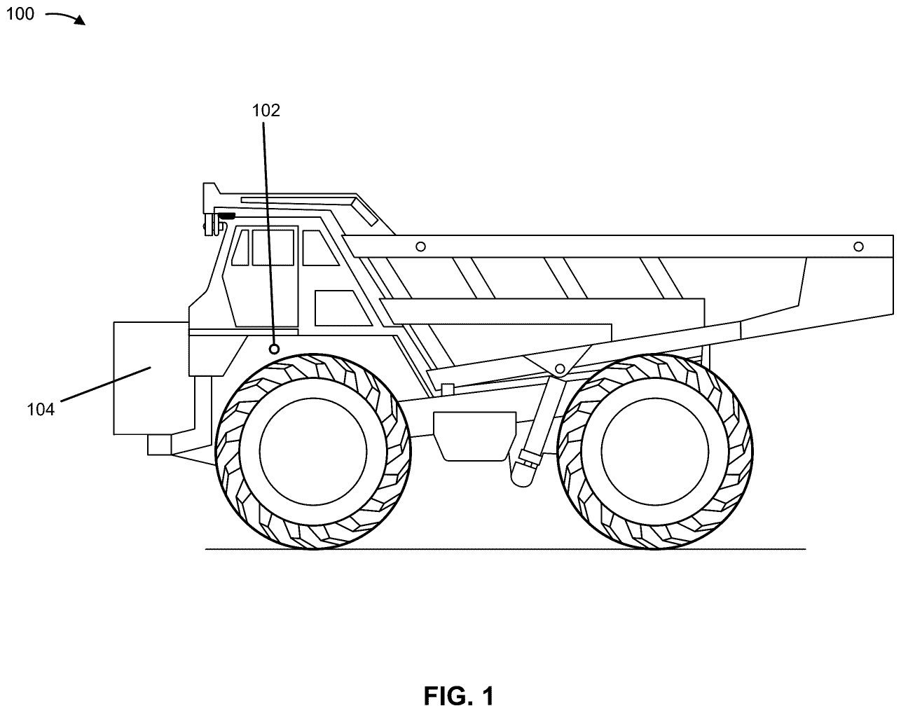

FIG. 1 is a diagram (e.g., a side-view) of an example work machine 100 described herein. The work machine 100 may be a mobile machine or vehicle, and may include a dump truck, a wheel loader, a hydraulic excavator, or another type of machine. Further, the work machine 100 may be a manned machine or an unmanned machine. The work machine 100 may be fully-autonomous, semi-autonomous, or remotely operated. As further shown in FIG. 1, the work machine 100 may include an energy storage system 102 (e.g., included within a chassis of the work machine 100) and a receptacle access point 104.

The work machine 100 may be configured to be at least partially powered by the energy storage system 102. That is, the work machine 100 may be a machine that utilizes electricity, hydrogen, methanol, ammonia, and/or other sources of energy other than a fossil fuel. As an example, the energy storage system 102 may include one or more batteries that store energy to be used to power one or more components of the work machine 100. For example, the work machine 100 may be a battery electric machine (BEM), a battery electric vehicle (BEV), a hybrid vehicle, a fuel cell and battery hybrid vehicle, or another machine that is at least partially powered by the energy storage system 102. The work machine 100 may include one or more electric engines, one or more electric motors, one or more electrical conversion systems, and/or other electrical components that are configured to convert and/or use energy, such as energy stored in the energy storage system 102, to cause overall movement of the work machine 100 across a work site and/or to cause movement of individual components or systems of the work machine 100.

The receptacle access point 104 provides an energy transfer interface (e.g., a wired energy transfer interface) for the energy storage system 102 and/or another fuel or energy storage of the work machine 100. For example, the receptacle access point 104 provides an energy transfer interface that can be physically connected to an energy transfer system (e.g., the energy transfer system 300 described herein) to allow an energy transfer from the energy transfer system to the energy storage system 102 (or vice versa) or other fuel or energy storage. The receptacle access point 104 may be located on a front of the work machine 100 (as shown), a side of the work machine 100, a back of the work machine 100, a bottom of the work machine 100, a top of the work machine 100, or at any other position on the work machine 100. The receptacle access point 104 is further described herein.

As indicated above, FIG. 1 is provided as an example. Other examples may differ from what is described in connection with FIG. 1.

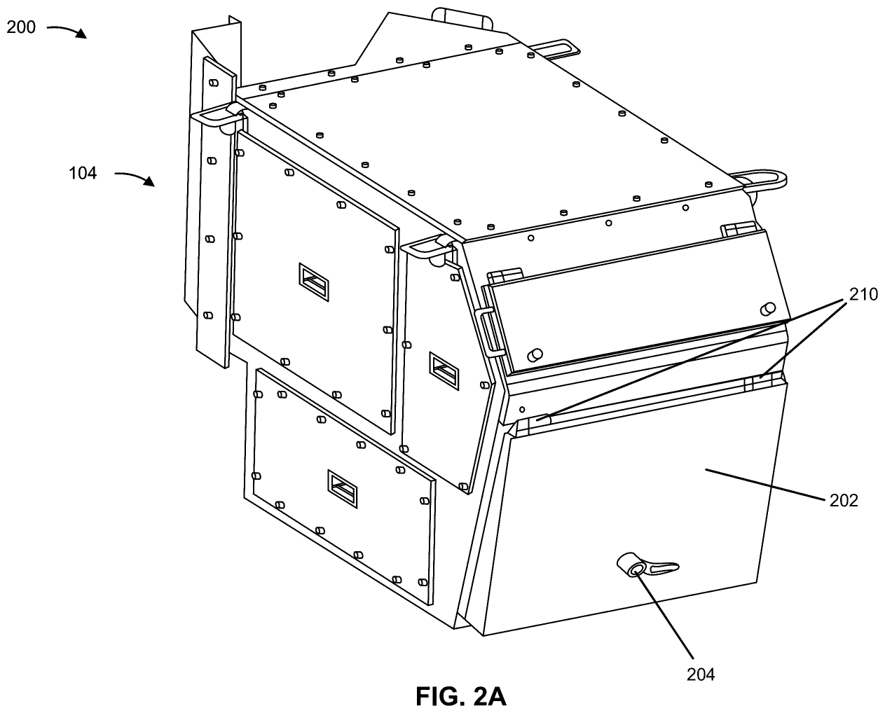

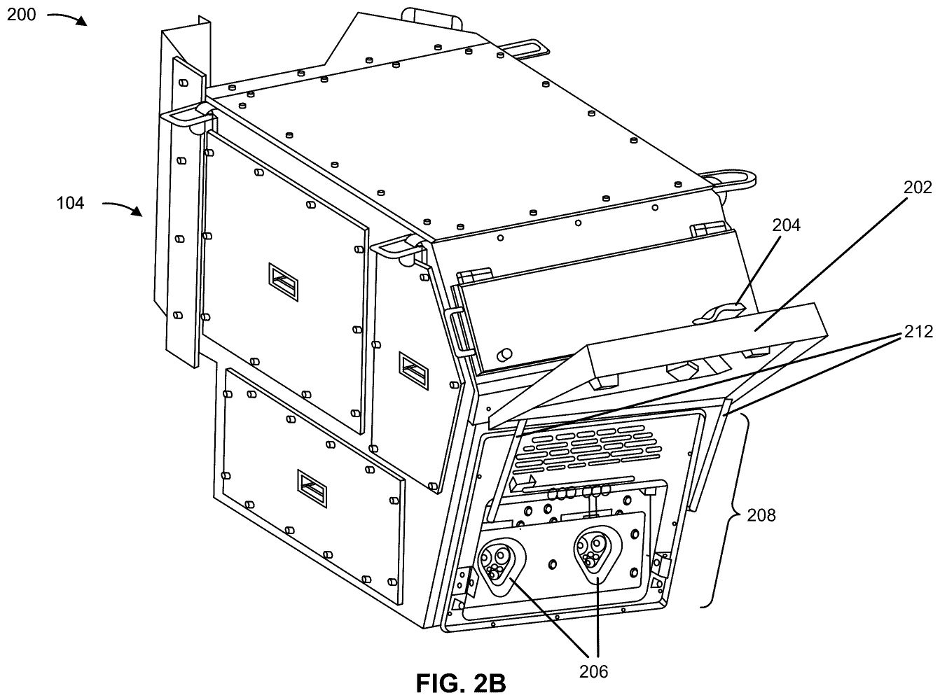

FIGS. 2A-2B are diagrams (e.g., front-angled views) of examples 200 of the receptacle access point 104 described herein. As shown in FIGS. 2A-2B, the receptacle access point 104 includes an access door 202, an access mechanism 204, and one or more receptacles 206. FIG. 2A shows the receptacle access point 104 in a closed state (e.g., when the access door 202 is in a closed position), and FIG. 2B shows the receptacle access point 104 in an open state (e.g., when the access door 202 is in an open position).

For example, when the access door 202 is in the closed position (e.g., such that edges of the access door 202 cover a flange of the interior panel 208) the access door 202 may prevent dirt, rocks, construction debris, waste matter, moisture, or other material (e.g., present at a work site at which the work machine 100 is operating) from accessing the interior panel 208. The access mechanism 204 is configured to be manipulatable to cause the access mechanism 204 to be engaged (e.g., to change from disengaged to engaged) or to be disengaged (e.g., to change from engaged to disengaged).

As shown in FIG. 2B, the one or more receptacles 206 may be included on the interior panel 208 of the receptacle access point 104. Each of the one or more receptacles 206 may be any type of physical component for coupling with a plug of an energy transfer system (e.g., a plug 402 of the energy transfer system 300 described herein) to enable an energy transfer from the energy transfer device to the energy storage system 102 (or vice versa). While the term “receptacles” are used herein, the one or more receptacles 206 may include plugs, ports, connectors, or any other type of wired energy transfer component.

As indicated above, FIGS. 2A-2B are provided as an example. Other examples may differ from what is described in connection with FIGS. 2A-2B.

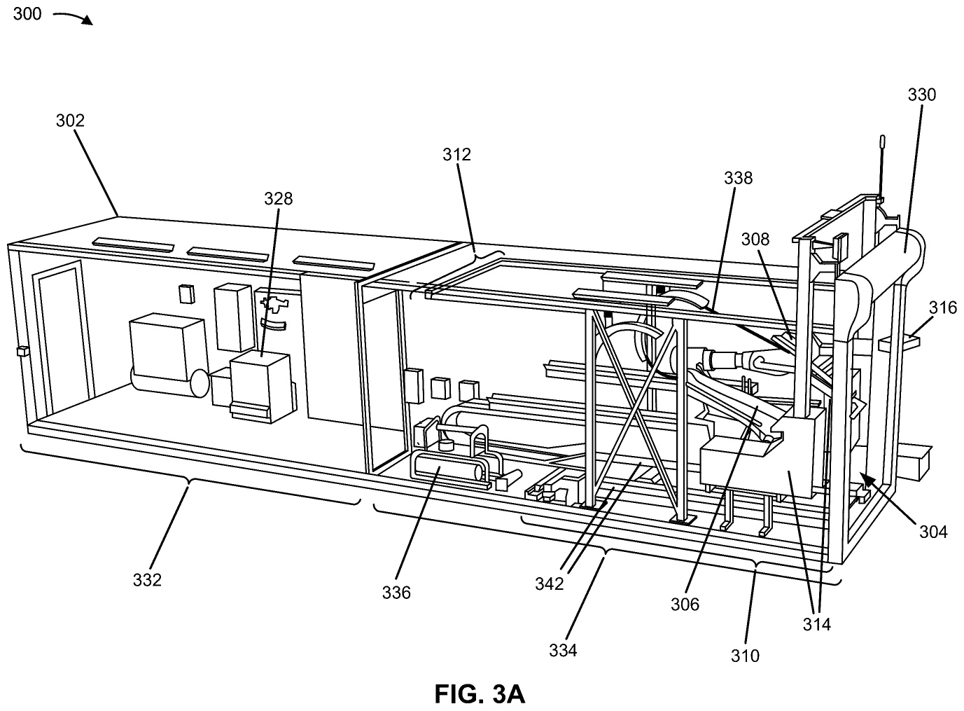

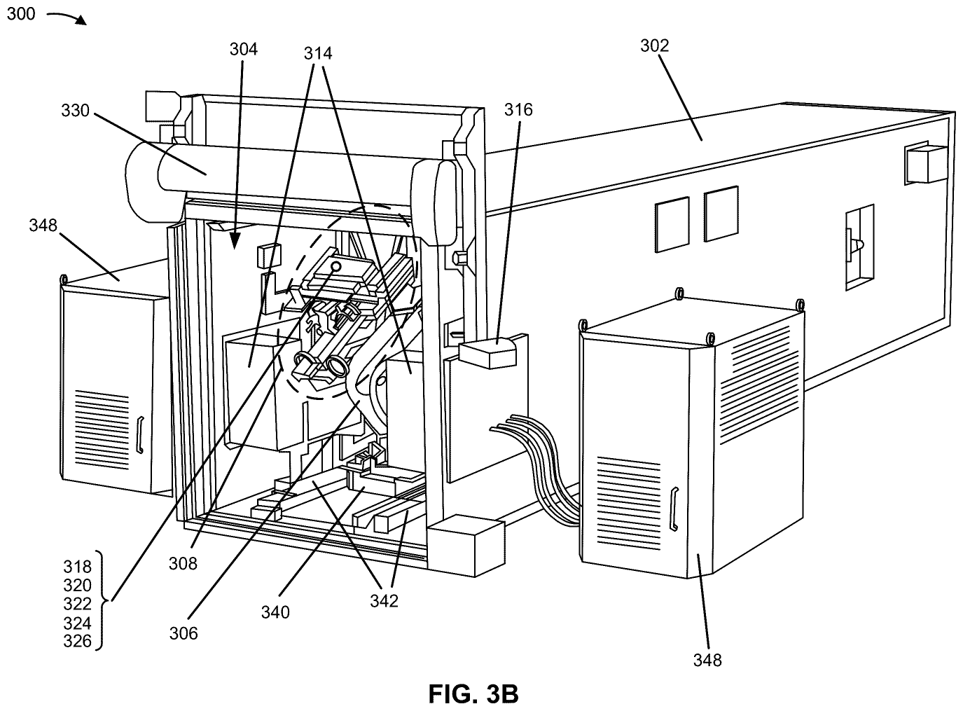

FIGS. 3A-3B are diagrams of an example energy transfer system 300. The energy transfer system 300 is configured to enable an energy transfer to and/or from the work machine 100 (e.g., to and/or from the energy storage system 102 of the work machine 100). In some implementations, the energy transfer system 300 is configured to autonomously enable the energy transfer (e.g., as further described herein), such as without any interaction with a human technician. However, other implementations include a human technician interacting with the energy transfer system 300 and, thus, the term “energy transfer system” includes any energy transfer system that is at least semi-autonomous (e.g., includes at least one autonomously controlled or operated system or component). FIG. 3A shows a side (cut-away) view of the energy transfer system 300, and FIG. 3B shows a front-angled view of the energy transfer system 300.

As shown in FIGS. 3A-3B, the energy transfer system 300 may include a housing 302 that includes a portal 304 at an end of the housing; a robotic system 306 that includes an end effector 308; a slide system 310; a cable management system 312; an energy transfer outlet system 314; a first camera system 316; a second camera system 318; a door opening system 320; a connector retention system 322; a connector protection system 324; a door closing system 326; and/or one or more controllers 328.

The housing 302 includes a metal, or other hard and/or weather resistant material, and may have a rectangular prism shape and/or other shapes. The housing 302 may include the portal 304 at an end of the housing 302 (e.g., instead of one of the short sides of the housing 302). The energy transfer system 300 may include a housing door 330 that is configured to cover the portal 304 when closed, and to uncover the portal 304 when open. For example, the housing door 330 may be a retractable door. The housing door 330, when closed, may protect an interior of the housing 302, such by preventing dirt, rocks, construction debris, waste matter, moisture, or other material (e.g., present at a work site at which the work machine 100 is operating) from accessing interior of the housing 302.

As shown in FIG. 3A, the interior of the housing 302 may be divided into a first interior portion 332 of the housing 302 and a second interior portion 334 of the housing 302 (e.g., that is separated by a wall, a door, or another separator). The first interior portion 332 of the housing 302 may include the one or more controllers 328 and/or one or more other electrical components, one or more pneumatic components, and/or one or more other communication components, among other examples, that enable operation of the systems and components included in the second interior portion 334 of the housing 302.

The second interior portion 334 of the housing 302 may include the slide system 310, the cable management system 312, and the energy transfer outlet system 314. The second interior portion 334 may also include additional systems and/or components for enabling operation of the robotic system 306 and/or an energy transfer operation, such as a pressure washer system 336 and one or more energy transfer cables 338 (e.g., that are configured to transmit energy to and/or from one or more plugs of the end effector 308, such as the one or more plugs 402 described herein). As shown in FIG. 3A, the second interior portion 334 may be associated with the end of the housing 302 that includes the portal 304. The slide system 310 is configured to move the robotic system 306, via the portal 304 of the housing 302, between an interior of the housing 302 (e.g., the second interior portion 334 of the housing 302) and an external environment (e.g., that surrounds the housing 302, such as at a work site). The slide system 310 may include a mount 340 for connecting to the robotic system 306 (e.g., for holding the robotic system 306 as the robotic system is moved by the slide system 310) and a slide apparatus 342 for moving the robotic system 306.

As shown in FIGS. 3A-3B, the first camera system 316 may be mounted on an exterior (e.g., an exterior side) of the housing 302. The first camera system 316 is configured to obtain first image data associated with the receptacle access point 104 (e.g., when mounted on the work machine 100), among other examples described in more detail herein. For example, the first camera system 316 may obtain the first image data to allow the one or more controllers 328 to determine whether the receptacle access point 104 is within an engagement range of the robotic system 306 (e.g., when the robotic system 306 is moved to the external environment by the slide system 310), such as to allow the robotic system 306 to interact with the receptacle access point 104 to initiate an energy transfer operation. The first camera system 316 may include one or more cameras or other image capturing devices. The first camera system 316 may be a stereo camera system, a three-dimensional (3D) camera system, a light detection and ranging (LiDAR) camera system, a non-visible light camera system (e.g., an infrared camera system), and/or another type of camera system. For example, the first camera system 316 may include two or more cameras arranged and/or configured to simulate or mimic binocular vision. For example, the two or more cameras may be configured to capture image data from different perspectives, enabling depth perception and the creation of 3D images or videos. The first camera system 316 may be configured within a container (e.g., a housing) mounted to the housing 302.

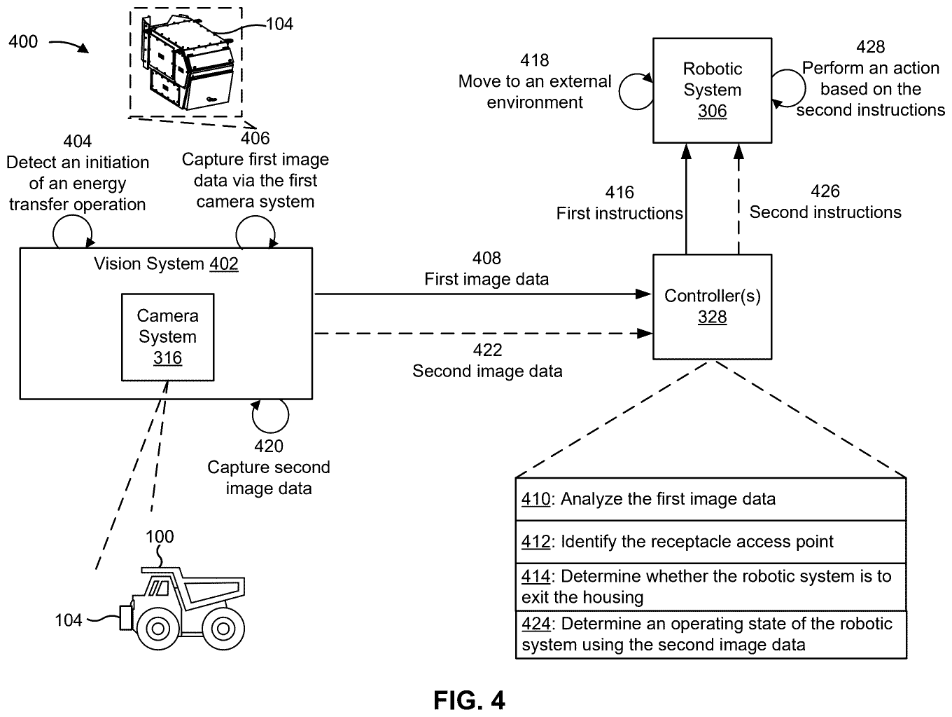

The robotic system includes the end effector 308, which may include (e.g., mounted to the end effector 308) the second camera system 318, the door opening system 320, the connector retention system 322, the connector protection system 324, and/or the door closing system 326. The second camera system 318, the door opening system 320, the connector retention system 322, the connector protection system 324, and/or the door closing system 326 are shown in more detail in FIG. 4.

The second camera system 318 is configured to obtain second image data associated with the access mechanism 204 of the receptacle access point 104 and/or of the one or more receptacles 206. The second camera system 318 may be a stereo camera system, a 3D camera system, a 3D camera system, a LiDAR camera system, a non-visible light camera system (e.g., an infrared camera system), and/or another type of camera system. For example, the second camera system 318 may include two or more cameras arranged and/or configured to simulate or mimic binocular vision. For example, the two or more cameras may be configured to capture image data from different perspectives, enabling depth perception and the creation of 3D images or videos.

The door opening system 320 is configured to open the access door 202 of the receptacle access point 104 (e.g., based on the location of the access mechanism 204 of the receptacle access point 104 identified by the one or more controllers 328). The door opening system 320 may include a manipulation system for manipulating the access mechanism 204 of the receptacle access point 104 to allow the access door 202 to open.

As indicated above, FIGS. 3A-3B are provided as an example. Other examples may differ from what is described in connection with FIGS. 3A-3B.

FIG. 4 is a diagram of an example 400 of a vision system 402 for the energy transfer system 300 described herein. As shown in FIG. 4, the vision system 402 includes the camera system 316 (e.g., the first camera system 316). The vision system 402 may also include the second camera system 318 (not shown in FIG. 4). The vision system 402 may be configured to obtain image data for the energy transfer system 300. The energy transfer system 300 (e.g., the one or more controllers 328) may use and/or analyze the image data to enable efficient operation of the robotic system 306 and/or to reduce a likelihood of damaging one or more components of the energy transfer system 300 during an energy transfer operation, among other examples as described in more detail elsewhere herein. For example, image data captured via the camera system 316 is used to calibrate operations of the robotic system 306 for the energy transfer operation. For example, the image data captured via the camera system 316 is used to enable hand-in-eye operation (e.g., hand-eye coordination or hand-eye calibration) of the robotic system 306 for the energy transfer operation.

The camera system 316 has a first field of view and the camera system 318 has a second field of view. The first field of view is larger than the second field of view. For example, the camera system 316 is configured to capture a larger or wider field of view than the second camera system 318. In other words, the first camera system 316 may be a far view or far-find camera system and the camera system 318 may be a near view or near-find camera system. As described elsewhere herein, the camera system 316 may be externally mounted (e.g., mounted on an exterior surface of the housing 302). In some examples, the camera system 316 includes a camera housing (e.g., in which the one or more cameras of the camera system 316 are configured).

As shown by reference number 404, the vision system 402 and/or the one or more controllers 328 may detect that an energy transfer operation for a work machine 100 is to be initiated. The vision system 402 and/or the one or more controllers 328 may detect that the work machine 100 is located in a position relative to the energy transfer system 300 that is associated with initiating the energy transfer operation. As another example, the vision system 402 and/or the one or more controllers 328 may obtain information from the work machine 100 that is indicative of initiating the energy transfer operation. For example, the work machine 100 may provide one or more wireless communications (such as radio frequency identification (RFID) communications, radio frequency signals, Bluetooth communications, local area network communications, Wi-Fi communications, or another type of wireless communication) that include the information that is indicative of initiating the energy transfer operation. The information may identify the work machine 100 and/or indicate that the energy transfer operation is to be initiated.

The one or more controllers 328 and/or the vision system 402 may use the information to initialize the camera system 316 in association with capturing image data. For example, the one or more controllers 328 and/or the vision system 402 may determine a relative location of the receptacle access point 104 of the work machine 100 (e.g., based on a type or category of the work machine 100). This enables the camera system 316 to capture image data in the relative location (e.g., rather than capturing and/or processing a larger amount of image data to enable the one or more controllers 328 to identify the location of the receptacle access point 104). This improves the efficiency of detecting and/or identifying the location of the receptacle access point 104.

As shown by reference number 406, the vision system 402 captures and/or obtains first image data via the camera system 316. For example, the camera system 316 may periodically capture image data. Additionally, or alternatively, the camera system 316 may capture image data based on, or in response to, an event. The event may include the camera system 316 obtaining instructions to capture the image data from the one or more controllers 328. As another example, the event may include the work machine 100 being in a position (e.g., relative to the energy transfer system 300) that is associated with initiating the energy transfer operation. The one or more controllers 328 may provide, and the vision system 402 (e.g., the camera system 316) may obtain, an indication to capture the first image data. For example, the one or more controllers 328 provide the indication to capture the first image data based on, or in response to, detecting that the energy transfer operation is to be initiated.

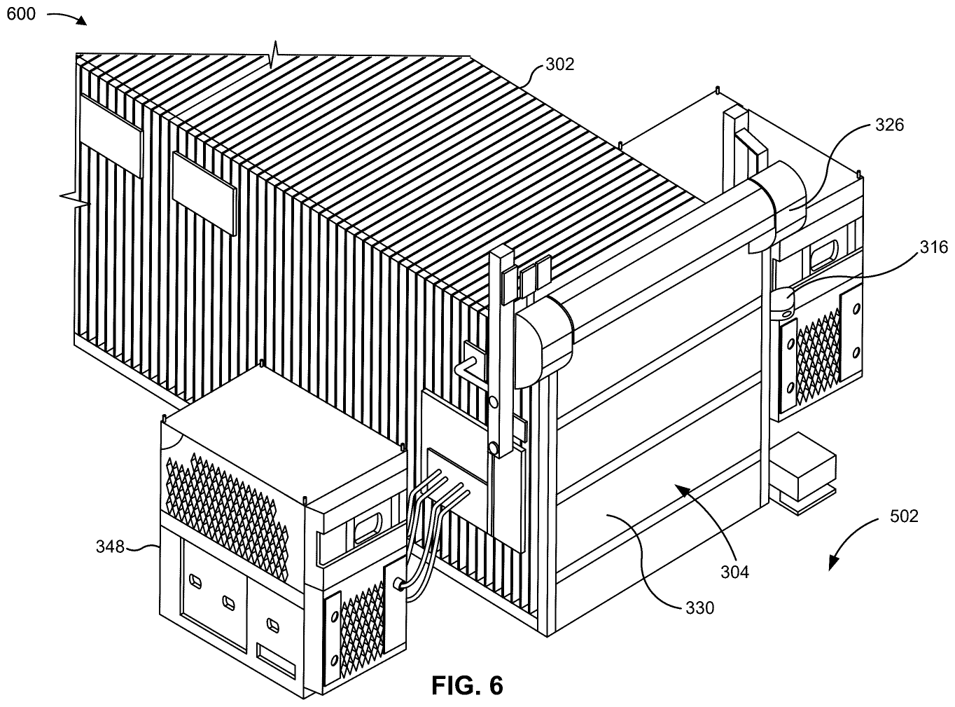

The camera system 316 captures and/or obtains the first image data while the robotic system 306 is inside of the housing 302. For example, the camera system 316 may capture and/or obtain the first image data while the housing door 330 of the portal 304 is in a closed position (e.g., as depicted in FIG. 6). The first image data may indicate evaluation information to be used by the one or more controllers 328 to evaluate the state and/or readiness of the energy transfer operation before causing the robotic system 306 to move to the external environment (e.g., external to the housing 302). This reduces a likelihood of damage to one or more components of the robotic system 306 because the amount of time that the robotic system 306 is operating in the external environment (e.g., that may have harsh conditions) is reduced and/or the robotic system 306 may not exit the housing 302 until the one or more controllers 328 have determined that the external environment is clear (e.g., that there are no unexpected objects or obstacles in the area in which the robotic system 306 will operate) and that the work machine 100 (e.g., the receptacle access point 104) is in a position to enable the energy transfer operation to be performed. This improves the efficiency of the energy transfer operation.

As shown by reference number 408, the vision system 402 (e.g., the camera system 316) may provide or transmit, and the one or more controllers 328 may obtain or receive, the first image data. The first image data may depict the work machine 100 and/or the receptacle access point 104 in the external environment. The first image data may be, or may include, point cloud data. For example, the point cloud data may include a collection of points in a 3D space representing the surfaces of one or more objects in the external environment. The camera system 316 may capture two or more images (e.g., from different perspectives) to enable depth perception through triangulation (e.g., the first camera system 316 and/or the one or more controllers 328 compare disparities between corresponding points in image pairs to calculate the distance to each point, constructing a detailed 3D representation of the external environment via the point cloud data). The point cloud data of the first image data may have a first density (e.g., a first density of points included in the point cloud data). For example, the first image data may include point cloud data representative or indicative of receptacle access point location(s) for the work machine 100.

As shown by reference number 410, the one or more controllers 328 may analyze the first image data. In some examples, the one or more controllers 328 may generate the point cloud data described above using the first image data. For example, the one or more controllers 328 may perform a computer vision operation to analyze the first image data. The one or more controllers 328 may identify one or more objects depicted via the first image data, such as the work machine 100 and/or the receptacle access point 104. In some examples, the one or more controllers 328 may determine whether any unexpected objects or structures are depicted in the first image data (e.g., which may interfere with the operation of the robotic system 306 in the external environment).

In some examples, the one or more controllers 328 determine, based on the first image data, location information of the work machine 100. The location information indicates a current location of the work machine 100 (e.g., relative to the energy transfer system 300). For example, the location information may indicate a coordinate location of the work machine 100 within a coordinate system mapping an external environment (e.g., external to the housing 302). The one or more controllers 328 may determine, based on or using the location information, whether the work machine 100 is in an energy transfer position relative to the energy transfer system 300. The energy transfer position is a position of the work machine 100 in which the robotic system 306 is enabled to reach and/or access the receptacle access point 104 of the work machine 100. The one or more controllers 328 may cause a notification indicating whether the work machine 100 is in the energy transfer position to be output by the energy transfer system 300. Providing or outputting the notification by the energy transfer system 300 improves the likelihood that the work machine 100 is positioned in the energy transfer position (e.g., because the work machine 100 and/or an operator of the work machine 100 do not need to solely rely on judgment or measurements from the perspective of the work machine 100 to position the work machine 100 in the energy transfer position).

The notification may include a visual notification, such as via one or more visual indicators included in the energy transfer system 300 (e.g., one or more lights or light-emitting diodes having colors indicating whether the work machine 100 is in the energy transfer position, such as a red light to indicate that the work machine 100 is not in the energy transfer position and a green light to indicate that the work machine 100 is in the energy transfer position). As another example, the notification may include an audio output (e.g., output via one or more speakers of the energy transfer system 300).

As another example, the one or more controllers 328 may cause the notification to be transmitted to one or more components of the work machine 100. The work machine 100 performs an action based on the notification. The action may include adjusting a position of the work machine 100 (e.g., if the work machine is autonomously or semi-autonomously controlled) to cause the work machine 100 to be in the energy transfer position (e.g., by moving the work machine 100 or by stopping the movement of the work machine 100). For example, the one or more controllers 328 (and/or an output component of the energy transfer system 300) may transmit, to a guidance system of the work machine 100, navigation instructions that are based on the location information and that are based on the energy transfer position for the energy transfer operation. The navigation instructions may cause the guidance system of the work machine 100 to position the work machine 100 in the energy transfer position.

The action may also include providing an operator output indicating whether the work machine 100 is in the energy transfer position (e.g., if the work machine 100 is at least partially controlled by an operator). For example, the work machine 100 may output (e.g., via a control panel or other mechanisms) an indication of whether the work machine 100 is in the energy transfer position. This enables the controller to accurately control the position, location, and/or orientation of the work machine 100 to improve the likelihood that the work machine 100 is positioned in the energy transfer position.

As shown by reference number 412, the one or more controllers 328 may identify the receptacle access point 104 of the work machine 100. For example, the one or more controllers 328 may identify, based on the first image data, a location of a receptacle access point 104 on the work machine 100. The one or more controllers 328 may perform one or more image analysis operations, such as feature extraction, matching, and/or geometric reasoning, among other examples, to identify the receptacle access point 104 based on distinct characteristics, such as shape, texture, and/or color, among other examples, of the receptacle access point 104. By using the first image data (e.g., the point cloud data), the one or more controllers 328 may determine a position and/or orientation of the receptacle access point 104. This improves the efficiency of the energy transfer operation. For example, even if the work machine 100 is in the correct position relative to the energy transfer system 300 to perform the energy transfer operation (e.g., even if the work machine 100 is in the energy transfer position), the external environment may include uneven and/or varying terrain, which may cause the receptacle access point 104 to be at different orientations relative to the energy transfer system 300. By determining the position and/or orientation of the receptacle access point 104 using the first image data, the one or more controllers 328 can detect these variations in orientation and instruct the robotic system 306 on the actual position and/or orientation of the receptacle access point 104 before the robotic system 306 begins operation and/or before the robotic system 306 moves to the external environment.

For example, the camera system 316 may enable the one or more controllers 328 to calibrate and/or configure hand-in-eye operation (e.g., hand-eye coordination or hand-eye calibration) of the robotic system 306 for the energy transfer operation (e.g., by the camera system 316 providing the first image data). The one or more controllers 328 may calibrate the hand-in-eye operation of the end effector 308 using the location and/or orientation of the receptacle access point 104 as determined via the first image data. The location and/or orientation of the receptacle access point 104 may be a calibration target for the calibration of the hand-in-eye operation of the end effector 308. For example, the one or more controllers 328 determine a pose (e.g., location and orientation) of the receptacle access point 104 using the first image data relative to the coordinate system used to control the movement of the robotic system 306 and/or the end effector 308. For example, the first image data may enable the one or more controllers 328 to perform improved sensor fusion (e.g., combining data from multiple sensors to obtain a more accurate, reliable, and/or comprehensive understanding of the external environment for the energy transfer operation) for the external environment before the robotic system 306 exits the housing 302. The calibration or configuration improves the likelihood that the robotic system 306 and/or the one or more controllers 328 are able to effectively and accurately translate visual information (obtained via the vision system 402) into actionable commands for the end effector 308, thereby improving the precision and reliability of the movements and/or actions of the end effector 308 for the energy transfer operation.

As shown by reference number 414, the one or more controllers 328 may determine whether the robotic system 306 is to exit the housing 302 as part of the energy transfer operation. The one or more controllers 328 may determine whether the robotic system 306 is to exit the housing 302 based on or using the first image data. For example, the one or more controllers 328 determine that the robotic system 306 is to exit the housing 302 based on determining that the work machine 100 is in the energy transfer position. Additionally, or alternatively, the one or more controllers 328 determine that the robotic system 306 is to exit the housing 302 based on determining the pose (e.g., location and/or orientation) of the receptacle access point 104. Additionally, or alternatively, the one or more controllers 328 determine that the robotic system 306 is to exit the housing 302 based on calibrating and/or configuring the end effector 308 (e.g., the hand-in-eye operation of the end effector 308) for the energy transfer operation.

Additionally, or alternatively, the one or more controllers 328 determine that the robotic system 306 is to exit the housing 302 based on determining that the external environment is in a clear state using or based on the first image data. The clear state may be associated with no unexpected objects, structures, and/or obstacles being located in the expected path or operating range of the robotic system 306 for the energy transfer operation. The one or more controllers 328 may selectively cause the robotic system 306 to exit the housing 302 based on the first image data. As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination. The one or more controllers 328 selectively cause, based on the first image data, the robotic system 306 to move from the interior of the housing 302 to the external environment to initiate the energy transfer operation. For example, the one or more controllers 328 may determine whether the robotic system 306 is to exit the housing 302 (e.g., based on the analysis of the first image data) and may selectively cause the robotic system 306 to move from the interior of the housing 302 to the external environment based on the determination.

For example, if the one or more controllers 328 detect an object, structure, or obstacle in the external environment (e.g., that has a likelihood of being in the expected path or operating range of the robotic system 306), then the one or more controllers 328 may detect that the external environment is not in the clear state (e.g., and may refrain from causing the robotic system 306 to exit the housing 302). The one or more controllers 328 may analyze the first image data (e.g., as described in connection with reference number 410). The one or more controllers 328 determine, based on the analysis of the first image data, that the external environment is in the clear state and that the work machine 100 is in an energy transfer position. The one or more controllers 328 cause the robotic system 306 to move from the interior of the housing 302 to the external environment based on determining that the external environment is in the clear state and that the work machine 100 is in the energy transfer position.

The one or more controllers 328 perform one or more actions to enable the robotic system 306 to exit the housing 302. The one or more controllers 328 cause the housing door 330 to transition from a closed position to an open position (e.g., as depicted in FIG. 3B). As shown by reference number 416, the one or more controllers 328 provide, and the robotic system 306 obtains, first instructions. The first instructions may indicate the position and/or orientation of the receptacle access point 104 (e.g., as determined via the first image data). The first instructions may be provided to a guidance system of the robotic system 306. The first instructions may enable the robotic system 306 to move to a position near the receptacle access point 104. For example, the one or more controllers 328 may provide receptacle access point locations to the guidance system of the robotic system 306.

As shown by reference number 418, the robotic system 306 may move to the external environment. The robotic system 306 moves to the external environment via the slide system 310. The slide system 310 is configured to move the robotic system 306, via the portal 304 of the housing 302, between an interior of the housing 302 (e.g., the second interior portion 334 of the housing 302) and the external environment (e.g., that surrounds the housing 302, such as at a work site). The one or more controllers 328 cause (e.g., via the first instructions) the robotic system 306 to move to the external environment via the slide system 310.

The robotic system 306 may move the end effector 308 into a ready position based on the first instructions. The ready position is associated with a distance between the end effector 308 and the receptacle access point 104 satisfying a threshold (e.g., the ready position may be a position near the receptacle access point 104). The one or more controllers 328 (e.g., by providing the first instructions) cause the end effector 308 to move to the ready position relative to the receptacle access point 104. In some examples, the robotic system 306 may perform one or more operations prior to being in the ready position, such as a cleaning operation to clean the receptacle access point 104. The one or more controllers 328 and/or the vision system 402 may detect that the end effector 308 is in the ready position (e.g., based on information obtained via the robotic system 306).

The robotic system 306 may perform one or more operations to enable the energy transfer via the end effector 308, such as opening the access door 202, and/or engaging or coupling with the one or more receptacles 206, among other examples. The one or more operations may be enabled via image data captured via the vision system 402, such as by the camera system 318.

In some examples, as shown by reference number 420, the camera system 316 may obtain, while the robotic system 306 is located in the external environment, second image data associated with the performance of the energy transfer operation. For example, while the robotic system 306 is performing the one or more operations to enable the energy transfer, the vision system 402 (e.g., the camera system 316) captures and/or obtains the second image data to enable the energy transfer operation to be monitored and/or evaluated. As shown by reference number 422, the vision system 402 (e.g., the camera system 316) may provide or transmit, and the one or more controllers 328 may obtain or receive, the second image data. The second image data may include point cloud data, one or more images, a stream of images, and/or a series of image frames (e.g., a video), among other examples.

As shown by reference number 424, the one or more controllers 328 determine an operating state of the robotic system 306 using the second image data. The operating state may indicate whether the energy transfer operation is being performed correctly and/or as expected. In some examples, the one or more controllers 328 detect, based on the second image data, an event that is indicative of unexpected operation for the energy transfer operation. The event may be associated with an object or person entering the external environment. For example, the one or more controllers 328 detect the event based on a distance between an object or person in the external environment and the robotic system 306 satisfying a distance threshold. As another example, the one or more controllers 328 detect the event based on a visual indication (e.g., indicated by the second image data) of a problem associated with the energy transfer operation. The visual indication may include arcing (e.g., a visible flash or discharge of electricity), sparks, a corona discharge (e.g., a visible ionization of the air surrounding end effector 308), smoke or fumes, discoloration or burning on a component (e.g., a component of the work machine 100 and/or the robotic system 306), and/or visible damage to a component, among other examples.

The one or more controllers 328 perform, based on detecting the event, one or more actions. The one or more actions are associated with mitigating or preventing damage to the robotic system 306 and/or the work machine 100 that may otherwise be caused by the event. The one or more actions may include causing the robotic system 306 to stop or pause the energy transfer operations, causing the end effector 308 to decouple or disengage the one or more receptacles 206, causing a flow of energy to be stopped or reduced (e.g., a flow of energy from the external transfer dispenser system 348), causing the end effector 308 to move away from the work machine 100, and/or causing the robotic system 306 to move to the interior of the housing 302, among other examples. In some examples, the one or more actions include providing, to the work machine 100, an alert or notification of the event. In some examples, the one or more actions include causing the energy transfer system 300 to output a notification of the event (e.g., via a visual indicator or an audio notification).

As shown by reference number 426, the one or more controllers 328 provide, and the robotic system 306 obtains, second instructions. The second instructions cause the robotic system 306 to perform the one or more actions that are associated with mitigating or preventing damage to the robotic system 306 and/or the work machine 100 that may otherwise be caused by the event. As shown by reference number 428, the robotic system 306 may perform an action based on the second instructions, such as the one or more actions described above. This reduces the likelihood of damage to the robotic system 306 and/or the work machine 100 that would otherwise be caused by the event.

In some examples, one or more components depicted and described in FIG. 4 (e.g., the one or more controllers 328, the vision system 402, the camera system 316, the camera system 318, and/or the robotic system 306) may include a bus, one or more processors, memory, an input component, an output component, and/or a communication component.

The bus may include one or more components that enable wired and/or wireless communication among the components of a component. The bus may couple together two or more components, such as via operative coupling, communicative coupling, electronic coupling, and/or electric coupling. For example, the bus may include an electrical connection (e.g., a wire, a trace, and/or a lead) and/or a wireless bus. A processor may include a central processing unit, a graphics processing unit, a microprocessor, a controller, a microcontroller, a digital signal processor, a field-programmable gate array, an application-specific integrated circuit, and/or another type of processing component. The processor may be implemented in hardware, firmware, or a combination of hardware and software. The processor may include one or more processors capable of being programmed to perform one or more operations or processes described elsewhere herein. The memory may include volatile and/or nonvolatile memory. For example, the memory may include random access memory (RAM), read only memory (ROM), a hard disk drive, and/or another type of memory (e.g., a flash memory, a magnetic memory, and/or an optical memory). The memory may include internal memory (e.g., RAM, ROM, or a hard disk drive) and/or removable memory (e.g., removable via a universal serial bus connection). The memory may be a non-transitory computer-readable medium. The memory may store information, one or more instructions, and/or software (e.g., one or more software applications) related to the operation of a component (e.g., the one or more controllers 328, the vision system 402, the first camera system 316, the second camera system 318, and/or the robotic system 306). The memory may include one or more memories that are coupled (e.g., communicatively coupled) to one or more processors, such as via the bus. Communicative coupling between a processor and memory may enable the processor to read and/or process information stored in the memory and/or to store information in the memory.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

As indicated above, FIG. 4 is provided as an example. Other examples may differ from what is described in connection with FIG. 4.

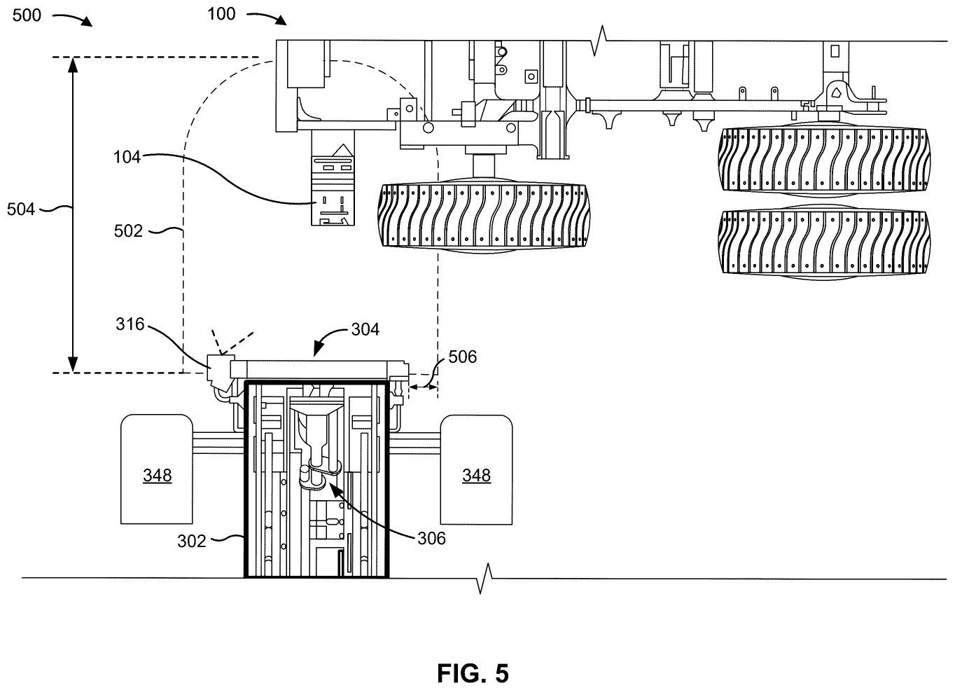

FIG. 5 is a diagram of an example 500 of an external environment 502 of the energy transfer system 300 described herein. The external environment 502 may be an area for which the camera system 316 captures image data. In some examples, the camera system 316 captures image data for one or more areas outside of the external environment 502. The work machine 100 is shown in FIG. 5 in the energy transfer position, described in more detail elsewhere herein.

The external environment 502 includes an area in front of the portal 304 of the housing 302. For example, the external environment 502 includes an area defined by a distance 504 (e.g., N meters) in front of the portal 304 and a distance 506 (e.g., M meters) on each side of the housing 302. The external environment 502 includes an area in which the robotic system 306 is expected to move or operate during energy transfer operations, as described in more detail elsewhere herein. The robotic system 306 is shown in FIG. 5 inside the housing 302. For example, the position of the robotic system 306 shown in FIG. 5 may be the position of the robotic system 306 while the camera system 316 captures or obtains the first image data, as described in connection with FIG. 4.

In some examples, the camera system 316 periodically captures or obtains image data of the external environment 502 (e.g., even if an energy transfer operation is not initiated). For example, the camera system 316 and/or the one or more controllers 328 may perform one or more monitoring or surveillance operations for the external environment 502 (e.g., one or more sentry operations). This enables the vision system 402 and/or the one or more controllers 328 to detect potential threats or incidents in the external environment 502. For example, the camera system 316 and/or the one or more controllers 328 may perform motion detection, event detection and/or classification (e.g., to detect and classify events associated with detected objects or motion within the external environment 502), and/or altering or notification (e.g., to one or more devices or systems to notify the device(s) or system(s) of detected events), among other examples, based on the periodic image data obtained by the camera system 316. This reduces the likelihood of unauthorized access to the energy transfer system 300 and/or enables the one or more controllers 328 to detect potential issues, problems, and/or threats, among other examples, associated with the energy transfer system 300.

As indicated above, FIG. 5 is provided as an example. Other examples may differ from what is described in connection with FIG. 5.

FIG. 6 is a diagram of the energy transfer system 300 described herein. FIG. 6 depicts the energy transfer system 300 in a state in which the camera system 316 captures the first image data described in connection with FIG. 4.

For example, as shown in FIG. 6, the housing door 330 may be in the closed position. This enables the housing door 330 to block access to the interior of the housing 302 (e.g., to block or prevent access to the interior of the housing 302 via the portal 304). For example, the housing door 330 may be closed via the door closing system 326. The housing door 330 may be opened (e.g., to a position in a similar manner as depicted in FIG. 3B) via the door closing system 326 based on, or in response to, the one or more controllers 328 determining that the robotic system 306 is to exit the housing 302, in a similar manner as described in more detail elsewhere herein. This prevents debris, objects, and/or people, among other examples, from entering the interior of the housing 302 where the robotic system 306 is located. This reduces the likelihood of damage to one or more components of the robotic system 306 (e.g., that may otherwise be caused by the harsh conditions of the external environment 502).

As indicated above, FIG. 6 is provided as an example. Other examples may differ from what is described in connection with FIG. 6.

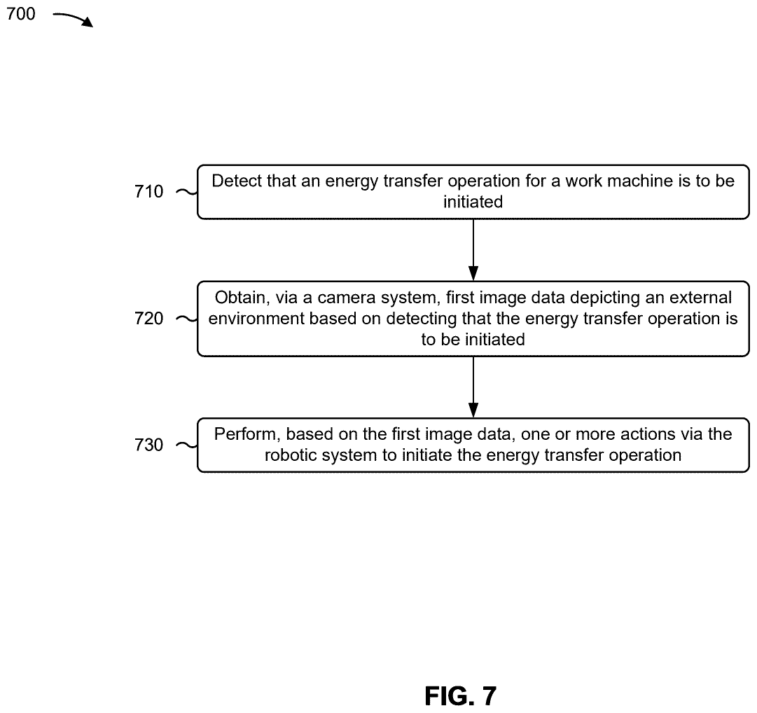

FIG. 7 is a flowchart of an example process 700 associated with a vision system for an energy transfer system. One or more process blocks of FIG. 7 may be performed by a system (e.g., the vision system 402 and/or the camera system 316). Additionally, or alternatively, one or more process blocks of FIG. 7 may be performed by another device or a group of devices separate from or including the system, such as another device or component that is internal or external to the vision system 402 and/or the camera system 316.

As shown in FIG. 7, process 700 may include detecting that an energy transfer operation for a work machine is to be initiated (block 710). For example, the system may detect that an energy transfer operation for a work machine is to be initiated, as described above.

As further shown in FIG. 7, process 700 may include obtaining, via a camera system, first image data depicting an external environment based on detecting that the energy transfer operation is to be initiated (block 720). For example, the system may obtain, via a camera system, first image data depicting an external environment based on detecting that the energy transfer operation is to be initiated, as described above. In some implementations, obtaining the first image data comprises obtaining the first image data while the robotic system is located within the housing.

As further shown in FIG. 7, process 700 may include performing, based on the first image data, one or more actions via the robotic system to initiate the energy transfer operation (block 730). For example, the system may perform, based on the first image data, one or more actions via the robotic system to initiate the energy transfer operation, as described above.

In some implementations, performing the one or more actions includes analyzing the first image data, determining, based on analyzing the first image data, that the external environment is in a clear state and that the work machine is in an energy transfer position, and causing the robotic system to move from an interior of the housing to the external environment based on determining that the external environment is in the clear state and that the work machine is in the energy transfer position. In some implementations, performing the one or more actions includes causing the robotic system to move to the external environment via a slide system, and causing an end effector of the robotic system to move to a ready position relative to the receptacle access point, wherein the ready position is based on the location of the receptacle access point.

In some implementations, process 700 includes identifying, based on the first image data, a location of a receptacle access point on the work machine.

In some implementations, process 700 includes obtaining, while the robotic system is located in the external environment, second image data associated with a performance of the energy transfer operation. In some implementations, process 700 includes detecting, based on the second image data, an event that is indicative of unexpected operation for the energy transfer operation, and causing, based on detecting the event, the energy transfer operation to be suspended.

In some implementations, process 700 includes determining, based on the first image data, location information of the work machine, and transmitting, to a guidance system of the work machine, navigation instructions that are based on the location information and that are based on an energy transfer position for the energy transfer operation.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

### INDUSTRIAL APPLICABILITY

The disclosed energy transfer system may be used to enable an energy transfer to and/or from a receptacle access point of a work machine (e.g., without any interaction with a human technician). Because the energy transfer system does not require interaction with a human technician, the energy transfer system may reduce the likelihood of damage to one or more components of a work site (e.g., that is associated with an industry, such as mining, construction, farming, or transportation).

As described elsewhere herein, automated and/or autonomous processes utilize image data to ensure precise functionality. Typically, a system may obtain image data at various points throughout the one or more automated and/or autonomous operations (e.g., as components and/or objects in an environment move). This may decrease the efficiency of the one or more automated and/or autonomous operations because there may be a delay associated with capturing, obtaining, and/or analyzing the image data at the various points. Additionally, a machine, such as a work machine, may operate in environments associated with harsh conditions (e.g., extreme temperatures, high wind speeds, a large amount of debris, and/or other harsh conditions), such as a mine site and/or other work sites. As a result, an automated and/or autonomous process for energy transfer to the machine in the manner described above (e.g., capturing, obtaining, and/or analyzing the image data at various points in an energy transfer operation) may increase the risk of damage to one or more components of the system due to the components operating in and/or being exposed to the harsh environment for more time.

The vision system (e.g., the vision system 402) described herein enables improved efficiency and reduced likelihood of damage to components for the energy transfer operation via the energy transfer system. For example, the energy transfer system includes an externally mounted camera system (e.g., the camera system 316) that is configured to obtain image data. The energy transfer system may use the image data to configure and/or calibrate one or more operations (e.g., one or more hand-in-eye operations) of an end effector of a robotic system included in the energy transfer system. The configuration and/or calibration of the end effector enables the robotic system to engage with one or more receptacles of a work machine to enable energy transfer. In some examples, the camera system captures the image data while the robotic system is position in the interior of a housing of the energy transfer system (e.g., with a housing door closed).

This reduces a likelihood of damage to one or more components of the robotic system because the amount of time that the robotic system is operating in the external environment (e.g., that may have harsh conditions) is reduced and/or the robotic system may not exit the housing until the energy transfer system has determined that the external environment is clear (e.g., that there are no unexpected objects or obstacles in the area in which the robotic system will operate) and that the work machine (e.g., the receptacle access point of the work machine) is in a position to enable the energy transfer operation to be performed. This improves the efficiency of the energy transfer operation.

The image data captured by the externally mounted camera system enables the energy transfer system to perform improved sensor fusion (e.g., combining data from multiple sensors to obtain a more accurate, reliable, and/or comprehensive understanding of the external environment for the energy transfer operation) for the external environment before the robotic system exits the housing. The calibration or configuration improves the likelihood that the robotic system is able to effectively and accurately translate visual information (obtained via the vision system and/or the externally mounted camera system) into actionable commands for the end effector, thereby improving the precision and reliability of the movements and/or actions of the end effector for the energy transfer operation.

What is claimed is:

1. An energy transfer system, comprising:
a housing;
a robotic system movable between an interior of the housing and an external environment, the robotic system including an end effector for coupling with receptacles for energy transfer;
a camera system configured on an exterior of the housing; and
one or more controllers configured to:
detect that an energy transfer operation for a work machine is to be initiated;
obtain, via the camera system and based on detecting that the energy transfer operation is to be initiated, first image data depicting the external environment; and
selectively cause, based on the first image data, the robotic system to move from the interior of the housing to the external environment to initiate the energy transfer operation.

2. The energy transfer system of claim 1, wherein the one or more controllers, to selectively cause the robotic system to move from the interior of the housing to the external environment, are configured to:
analyze the first image data;
determine, based on analyzing of the first image data, that the external environment is in a clear state and that the work machine is in an energy transfer position; and
cause the robotic system to move from the interior of the housing to the external environment based on determining that the external environment is in the clear state and that the work machine is in the energy transfer position.

3. The energy transfer system of claim 1, wherein the one or more controllers are further configured to:
identify, based on the first image data, a location of a receptacle access point on the work machine.

4. The energy transfer system of claim 3, wherein the one or more controllers, to selectively cause the robotic system to move from the interior of the housing to the external environment, are configured to:
cause the robotic system to move to the external environment via a slide system; and
cause the end effector to move to a ready position relative to the receptacle access point, wherein the ready position is based on the location of the receptacle access point.

5. The energy transfer system of claim 1, wherein the one or more controllers, to obtain the first image data, are configured to:
obtain the first image data while the robotic system is located within the housing.

6. The energy transfer system of claim 1, wherein the one or more controllers are further configured to:
obtain, while the robotic system is located in the external environment, second image data associated with a performance of the energy transfer operation.

7. The energy transfer system of claim 6, wherein the one or more controllers are further configured to:
detect, based on the second image data, an event that is indicative of unexpected operation for the energy transfer operation; and
perform, based on detecting the event, one or more actions.

8. The energy transfer system of claim 1, wherein the one or more controllers are further configured to:
determine, based on the first image data, location information of the work machine; and
transmit, to a guidance system of the work machine, navigation instructions that are based on the location information and that are based on an energy transfer position for the energy transfer operation.

9. A method, comprising:
detecting, by a system, that an energy transfer operation for a work machine is to be initiated;
obtaining, by the system and via a camera system, first image data depicting an external environment based on detecting that the energy transfer operation is to be initiated,
wherein the external environment is external to a housing of a robotic system that is associated with the system; and
performing, by the system and based on the first image data, one or more actions via the robotic system to initiate the energy transfer operation.

10. The method of claim 9, wherein performing the one or more actions comprises:
analyzing the first image data;
determining, based on analyzing the first image data, that the external environment is in a clear state and that the work machine is in an energy transfer position; and
causing the robotic system to move from an interior of the housing to the external environment based on determining that the external environment is in the clear state and that the work machine is in the energy transfer position.

11. The method of claim 9, further comprising:
identifying, based on the first image data, a location of a receptacle access point on the work machine.

12. The method of claim 11, wherein performing the one or more actions comprises:
causing the robotic system to move to the external environment via a slide system; and
causing an end effector of the robotic system to move to a ready position relative to the receptacle access point, wherein the ready position is based on the location of the receptacle access point.

13. The method of claim 9, wherein obtaining the first image data comprises:
obtaining the first image data while the robotic system is located within the housing.

14. The method of claim 9, further comprising:
obtaining, while the robotic system is located in the external environment, second image data associated with a performance of the energy transfer operation.

15. The method of claim 14, further comprising:
detecting, based on the second image data, an event that is indicative of unexpected operation for the energy transfer operation; and
causing, based on detecting the event, the energy transfer operation to be suspended.

16. The method of claim 9, further comprising:
determining, based on the first image data, location information of the work machine; and
transmitting, to a guidance system of the work machine, navigation instructions that are based on the location information and that are based on an energy transfer position for the energy transfer operation.

17. A camera system, comprising:
one or more cameras;
one or more memories; and
one or more processors, communicatively coupled to the one or more memories, configured to:
obtain an indication that an energy transfer operation for a work machine is to be initiated;
obtain, via the one or more cameras and based on detecting that the energy transfer operation is to be initiated, image data depicting an external environment,
wherein the external environment is external to a housing of an energy transfer system; and
provide, to one or more components of the energy transfer system, the image data to initiate the energy transfer operation.

18. The camera system of claim 17, wherein the housing includes a robotic system that is movable between an interior of the housing and the external environment, and wherein the one or more cameras are mounted on an exterior of the housing.

19. The camera system of claim 18, wherein the one or more processors, to obtain the image data, are configured to:
obtain the image data while the robotic system is in the interior of the housing.

20. The camera system of claim 17, wherein the one or more cameras are stereo cameras, and
wherein the image data includes point cloud data.
